(19) United States
(12) Patent Application Publication
(10) Pub. No.: US 2024/0203458 A1
(43) Pub. Date: Jun. 20, 2024

(54) DATA MODIFICATION METHOD, DATA REPRODUCTION METHOD, PROGRAM, DATA MODIFICATION DEVICE

(71) Applicant: YAMAHA CORPORATION, Hamamatsu-shi (JP)

(72) Inventors: Yoshimasa ISOZAKI, Hamamatsu-shi (JP); Satoshi USA, Hamamatsu-shi (JP); Takuya FUJISHIMA, Hamamatsu-shi (JP); Kazuhiko YAMAMOTO, Hamamatsu-shi (JP)

(21) Appl. No.: 18/592,589

(22) Filed: Mar. 1, 2024

Related U.S. Application Data
(63) Continuation of application No. PCT/JP2021/032374, filed on Sep. 2, 2021.

(51) Int. Cl. G11B 27/10; G06F 3/04842; G06F 3/04847; G10H 1/00; G11B 27/00; G11B 27/031

(52) U.S. Cl. CPC G11B 27/10; G06F 3/04842; G06F 3/04847; G10H 1/0008; G11B 27/005; G11B 27/031; G10H 2210/381; G10H 2220/116

(57) ABSTRACT

A data modification method of controlling sound , the method according to an embodiment includes providing a selection user interface that allows a user to select a modification mode to be applied to sound control data defining timing information of a sound generation from among a plurality of modification modes including a first modification mode and a second modification mode, modifying the sound control data by correcting the timing information and adding correction information according to an amount of correction of the timing information in a predetermined data section to the predetermined data section, in a state where the first modification mode is selected to be applied, and modifying the sound control data by correcting the timing information based on beat positions according to a predetermined tempo, in a state where the second modification mode is selected to be applied.

### CROSS-REFERENCE TO RELATED APPLICATIONS

This application is a Continuation of International Patent Application No. PCT/JP2021/032374, filed on Sep. 2, 2021, the entire contents of which are incorporated herein by reference.

### FIELD

The present disclosure relates to a method of modifying data for controlling sounds.

### BACKGROUND

There is a technique of generating a sound waveform signal by performing an automatic performance based on data (hereinafter referred to as sound control data) for controlling a sound generation of MIDI data and the like. In general, speed (tempo) of the automatic performance is defined in the sound control data. That is, when the sound control data is reproduced, performance sounds recorded in the sound control data are played. As disclosed in Japanese Laid-Open Patent Publication No. H8-272362, Japanese Laid-Open Patent Publication No. H9-16169, and Utility Model Registration No. 3227548, a technique for controlling the tempo in accordance with an operation of a user has also been developed. The control of the tempo by the user is realized, for example, by the user shaking a portable device held in a hand like a command rod. Therefore, the performance sounds recorded in the sound control data are not played as it is, but the performance sound whose play speed is modified in accordance with the operation of the user is played.

### SUMMARY

According to an embodiment of the present disclosure, there is provided a data modification method of controlling sound, the method including providing a selection user interface that allows a user to select a modification mode to be applied to sound control data defining timing information of a sound generation from among a plurality of modification modes including a first modification mode and a second modification mode, modifying the sound control data by correcting the timing information and adding correction information according to an amount of correction of the timing information in a predetermined data section to the predetermined data section, in a state where the first modification mode is selected to be applied, and modifying the sound control data by correcting the timing information based on beat positions according to a predetermined tempo, in the state where the second modification mode is selected to be applied.

According to an embodiment of the present disclosure, there is provided a data modification method of controlling sound, the method including detecting a plurality of beat positions from sound control data defining timing information of sounds recorded with a predetermined tempo, correcting the timing information based on a relationship between the plurality of beat positions and the predetermined tempo, and modifying the sound control data by adding correction information to a predetermined data section according to an amount of correction of the timing information in the predetermined data section.

### BRIEF DESCRIPTION OF DRAWINGS

FIG. 1 is a diagram showing a system configuration according to an embodiment.

FIG. 2 is a diagram showing a hardware configuration of a portable device and an electronic musical instrument according to an embodiment.

FIG. 3 is a flowchart showing a process of a recording mode according to an embodiment.

FIG. 4 is a diagram showing an example of a recording user interface (before an instruction to start recording).

FIG. 5 is a diagram showing an example of a recording user interface (after an instruction to start recording).

FIG. 6 is a diagram showing an example of a selection user interface.

FIG. 7 is a flowchart showing a process of a recording mode (a part subsequent to FIG. 3) according to an embodiment.

FIG. 8 is a flow chart showing an AI quantization process according to an embodiment.

FIG. 9 is a diagram showing an example of a beat correction user interface (before a correction instruction).

FIG. 10 is a diagram showing an example of a beat correction user interface (before a correction instruction).

FIG. 11 is a diagram for explaining an example of sound control data.

FIG. 12 is a flowchart showing a data correction process according to the embodiment.

FIG. 13 is a diagram for explaining an example of correcting timing information.

FIG. 14 is a diagram for comparing and explaining the sound control data before and after modification.

FIG. 15 is a flow chart showing a MIDI quantization process according to an embodiment.

FIG. 16 is a diagram showing an example of a quantization setting user interface.

FIG. 17 is a flowchart showing a delay offset process according to an embodiment.

FIG. 18 is a diagram showing an example of an offset setting user interface.

FIG. 19 is a diagram for comparing and explaining sound control data before and after a delay offset.

FIG. 20 is a diagram for comparing and explaining sound control data before and after a delay offset.

FIG. 21 is a flowchart showing a data reproduction process according to an embodiment.

FIG. 22 is a diagram showing an example of a reproduction user interface.

### DESCRIPTION OF EMBODIMENTS

In some cases, a selected automatic performance is realized by selecting one of an automatic performance in a tempo control by an operation of a user and an automatic performance in a predetermined tempo control. In such a case, it is desirable that sound control data capable of performing tempo control by the operation of the user and sound control data capable of performing predetermined tempo control are generated as common data. Since the sound control data in which a tempo is determined in advance generally exists, it is desirable to modify the sound control data in which the tempo is determined in advance so that the sound control data can also be used as the sound control data capable of performing tempo control by the user.

According to an embodiment of the present disclosure, it is possible to easily modify sound control data in which a performance sounds are recorded into data that enables tempo control by an operation of a user.

Hereinafter, an embodiment of the present invention will be described in detail with reference to the drawings. The following embodiments are examples, and the present invention should not be construed as being limited to these embodiments. In the drawings referred to in the present embodiment, the same or similar parts are denoted by the same reference signs or similar reference signs (only denoted by A, B, and the like after the numerals), and repetitive description thereof may be omitted.

### 1. Overall Configuration

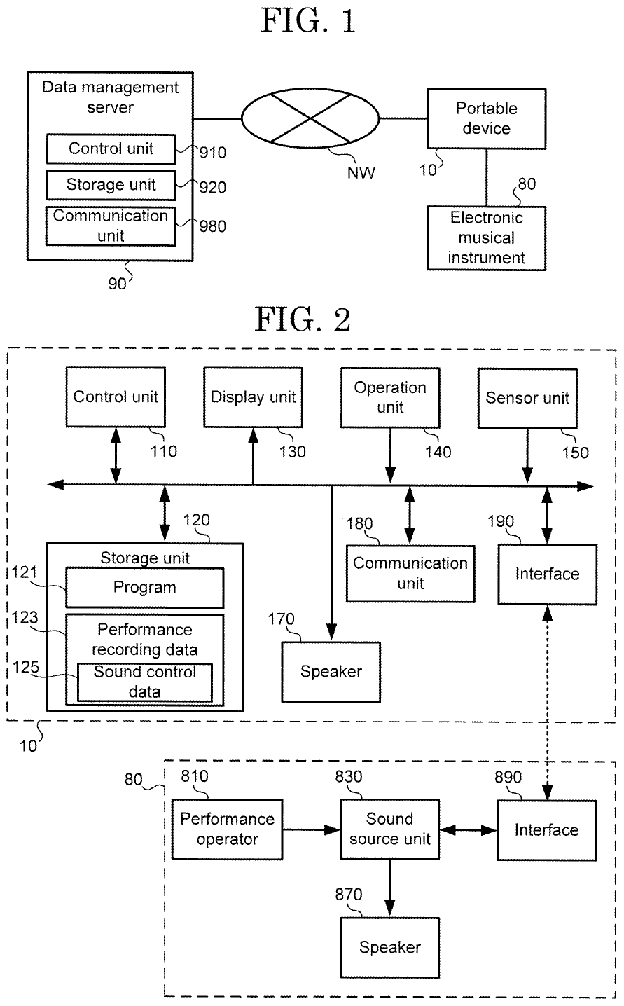

FIG. 1 is a diagram showing a system configuration according to an embodiment. A system shown in FIG. 1 includes a portable device 10 and a data management server 90 which are connected each other via a networked NW such as the Internet. The system further includes an electronic musical instrument 80 connected to the portable device 10. At least a part of the functions of the electronic musical instrument 80 may be included in the portable device 10. In this example, the portable device 10 is a portable communication terminal such as a smartphone. In this example, the electronic musical instrument 80 is an electronic keyboard device such as an electronic piano.

The portable device 10 can record a performance on the electronic musical instrument 80 and reproduce the recorded performance on the electronic musical instrument 80. In this reproduction, it is possible to select either the reproduction of the recorded performance as it is or the reproduction at a speed according to an operation of a user (for example, an operation of shaking the portable device 10 like a command bar). The portable device 10 generates data corresponding to the recorded performance, and can modify the data so that the data can be used in any of the reproduction described above. A specific process for realizing each of such functions will be described later.

The data management server 90 includes a control unit 910, a storage unit 920, and a communication unit 980. The control unit 910 includes a CPU, a RAM and a ROM. The control unit 910 executes a program stored in the storage unit 920 using the CPU, thereby performing a process according to an instruction described in the program. The storage unit 920 includes a storage device such as a nonvolatile memory or a hard disk drive. The communication unit 980 includes a communication module connected to the networked NW for communicating with other devices. The data management server 90 stores a part of data generated by the portable device 10 in the storage unit 920, and executes processes using the data. The details of a specific process will be described later. In an embodiment, the data management server 90 may not be present.

### 2-1. Configuration of Portable Device

FIG. 2 is a diagram showing a hardware configuration of a portable device and an electronic musical instrument according to an embodiment. The portable device 10 includes a control unit 110, a storage unit 120, a display unit 130, an operation unit 140, a sensor unit 150, a speaker 170, a communication unit 180, and an interface 190. The portable device 10 is not limited to include all of these configurations, and may further include other configurations such as a camera and a position detection unit.

The control unit 110 is an example of a computer including a processor such as the CPU (Central Processing Unit) and a storage device such as the RAM. The control unit 110 executes a program 121 stored in the storage unit 120 using the CPU (processor), and causes the portable device 10 to realize functions for executing various processes to be described later.

The storage unit 120 is a storage device such as a nonvolatile memory or a hard disk drive. The storage unit 120 stores the program 121 executed by the control unit 110 and various kinds of data necessary for executing the program 121. The program 121 is installed in the portable device 10 by being downloaded from the data managing server 90 or another server through the network NW and being stored in the storage unit 120. The program 121 may be provided in a state of being recorded on a non-transitory computer-readable storage medium (for example, a magnetic storage medium, an optical storage medium, a magneto-optical storage medium, a semiconductor memory, or the like). In this case, the portable device 10 may be provided with a device for reading the storage medium. The storage unit 120 is also an example of the storage medium.

The data stored in the storage unit 120 includes, for example, performance recording data 123. The performance recording data 123 includes various data related to a performance, and includes, for example, metadata such as a name of a performance music and data related to performance sounds. The data related to the performance sounds includes sound control data 125 that defines timing information of a sound generation by the performance. The sound control data 125 is data described in a predetermined format, and is, for example, data described in a MIDI format. In this case, the timing information of the sound generation is information indicating a timing at which the sound is generated, and is indicated by, for example, information such as note-on, note-off, delta time, and tempo. Other information related to the sound generation, for example, information such as pitch (note number) is also included in the sound control data 125.

The display unit 130 is a display having a display region for displaying various images under the control of the control unit 110. The displayed image includes a plurality of user interfaces described later. The operation unit 140 is an operation device that outputs a signal corresponding to an operation of a user to the control unit 110. In this example, the operation unit 140 is a touch sensor provided on the surface of the display unit 130. Therefore, the display unit 130 and the operation unit 140 are used as a touch panel by functions of each other. The operation unit 140 may include a switch or the like disposed in a housing of the portable device 10.

The sensor unit 150 outputs a signal in response to a movement of the portable device 10 to the control unit 110. For example, the sensor unit 150 includes an acceleration sensor, a gyro sensor, and the like, and measures the movement of the portable device 10. The speaker 170 emits a sound by amplifying and outputting a sound waveform signal supplied from the control unit 110.

The communication unit 180 is a wireless communication module that is connected to the network NW and communicates with other devices such as the data managing server 90 connected to the network NW under the control of the control unit 110. The interface 190 includes a communication module for communicating with other devices such as the electronic musical instrument 80 by infrared communication or short-range wireless communication. The interface 190 is used to communicate without via the networked NW. The interface 190 may include a module that performs wired communication instead of the wireless communication.

### 2-2. Configuration of Electronic Musical Instrument

As described above, the electronic musical instrument 80 is an electronic keyboard device such as an electronic piano, and includes a performance operator 810, a sound source unit 830, a speaker 870, and an interface 890. The performance operator 810 includes a plurality of keys, and outputs a signal in response to an operation on each key to the sound source unit 830. The interface 890 includes a communication module for communicating with an external device wirelessly or by wire. In this example, the interface 890 is connected to the interface 190 of the portable device 10 by short-range wireless communication to transmit and receive data in a predetermined format (in this example, the MIDI format).

The sound source unit 830 includes a DSP (Digital Signal Processor) and generates a sound waveform signal in accordance with a sound instruction signal. The sound instruction signal corresponds to a signal output from the performance operator 810 and data transmitted from the portable device 10 via the interface 890. In addition, the sound source unit 830 converts the sound instruction signal corresponding to the signal output from the performance operator 810 into MIDI format data, and outputs the data to the interface 890. Thus, the electronic musical instrument 80 can also transmit data (hereinafter, sometimes referred to as performance information) corresponding to an operation on the performance operator 810 to the portable device 10.

### 3. Recording Mode

Next, a process of recording a performance on the electronic musical instrument 80 in the portable device 10 will be described. A processing mode in which the performance is recorded in this manner is referred to as a recording mode. When an instruction to start the recording mode is input by the user, the portable device 10 starts the process of the recording mode.

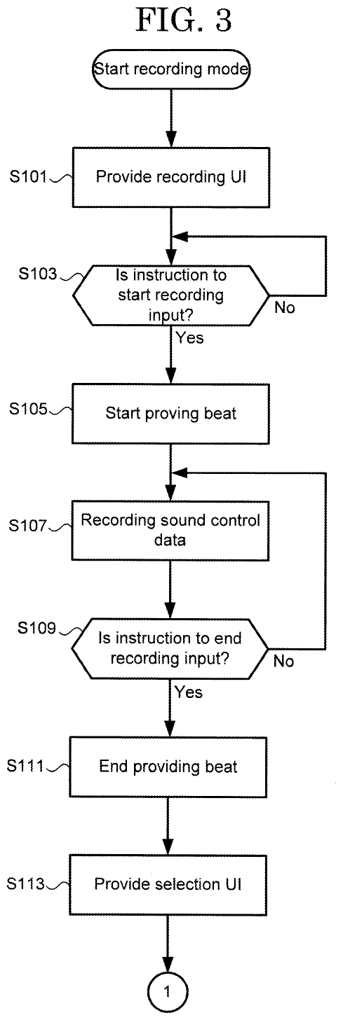

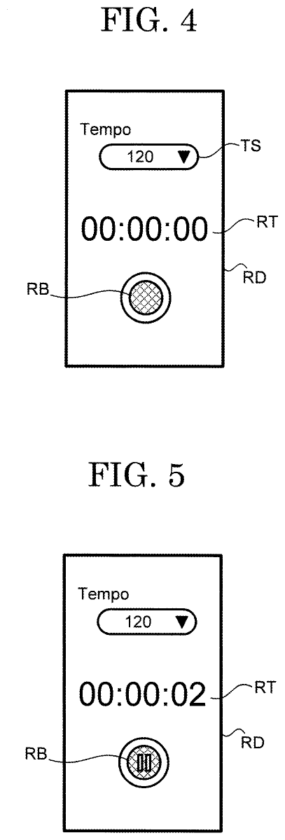

FIG. 3 is a flowchart showing a process of a recording mode according to an embodiment. FIG. 4 is a diagram showing an example of a recording user interface (before an instruction to start recording). FIG. 5 is a diagram showing an example of the recording user interface (after the recording instruction). The control unit 110 provides a recording user interface (recording UI) to the user by displaying an image to be described below on the display unit 130 (step S101). The recording user interface (hereinafter, sometimes referred to as an interface RD) shown in FIG. 4 is a display example before an instruction to start performance recording. The interface RD includes a region TS for setting a tempo at the time of recording (hereinafter, may be referred to as a recording tempo), a region RT for displaying recording times, and a recording button RB for instructing to start and end the recording.

The control unit 110 waits until the instruction to start recording of the performance is input (step S103; No). The instruction to start the recording is input to the portable device 10 (step S103; Yes) by the recording button RB shown in FIG. 4 being operated, the control unit 110 changes the displaying of the recording button RB as shown in FIG. 5, and starts providing a beat (beat information) to the user in order to start the recording the performance (step S105). The provision of the beat is realized, for example, by generating a metronome sound from the portable device 10. The metronome sound is generated corresponding to each beat specified at an interval determined by the recording tempo. For example, if the recording tempo is 120, the metronome sound is generated at a length of 500 milliseconds of one beat. The portable device 10 is not limited to the case where the beat is provided to the user by sound, and the beat may be provided by light, vibration, or the like.

The control unit 110 records the sound control data 125 in the storage unit 120 (step S107) based on the performance information provided from the electronic musical instrument 80 until an instruction to end the recording is input (step S109; No). In this case, the provision of the beat to the user is continued. When the instruction to end the recording is input to the portable device 10 (step S109; Yes) by operating the recording button RB shown in FIG. 5, the control unit 110 ends the provision of the beat (step S111). Subsequently, the control unit 110 provides a selection user interface (selection UI) by displaying an image to be described below on the display unit 130 (step S113).

It is possible to provide a process to be performed after recording the sound control data 125 based on the performance by providing the selection user interface in this manner. On the other hand, the control unit 110 may temporarily end the recording of the sound control data 125 at the time when the recording is finished in accordance with an instruction from the user. In this case, the control unit 110 may provide a selection user interface according to the instruction from the user, and may further provide a user interface for specifying the sound control data 125 to be processed. Other than the sound control data 125 recorded in the recording mode may be specified as a processing target.

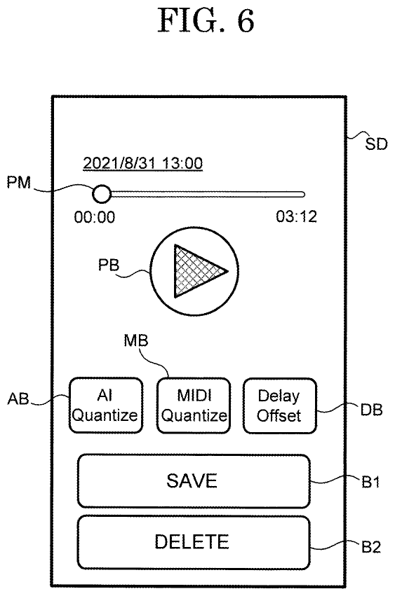

FIG. 6 is a diagram showing an example of the selection user interface. As shown in FIG. 6, the selection user interface (hereinafter, sometimes referred to as an interface SD) includes an interface for selecting a modification mode to be applied to the recorded sound control data 125 from a plurality of different modification modes. The plurality of modification modes may be any modification mode as long as the sound control data 125 is modified by different processes. The plurality of modification modes may include at least two modification modes for modifying the sound control data 125 by correcting the timing information in different ways. In this example, the plurality of modification modes includes three modification modes. The three modification modes correspond to an “AI Quantization” (first modification mode), a “MIDI Quantization” (second modification mode), and a “Delay Offset” (third modification mode). The interface SD includes modification selection buttons AB, MB, and DB corresponding to the respective modification modes. The “AI quantization” is a process of detecting a beat position based on the sound control data 125 and modifying the sound control data 125 so as to correct the timing information according to a relationship between the beat position specified based on the original sound control data 125 and the detected beat position. When detecting the beat position, an AI (Artificial Intelligence) technique is used. The “MIDI quantization” is a process of modifying the sound control data 125 so as to correct the timing information in accordance with a specified resolution. The “Delay Offset” is a process of modifying the sound control data 125 so as to offset timing information corresponding to a plurality of sounds. These specific processing methods will be described later.

The interface SD includes a save button B1 for storing the sound control data 125, a delete button B2 for discarding the sound control data 125, and a play button PB for playing back the sound control data 125. When the play button PB is operated, the sound control data 125 is read out and the sound indicated by the sound control data 125 is played. The sound may be generated in the portable device 10 or may be generated in the electronic musical instrument 80. In the case where the sound is generated by the electronic musical instrument 80, the sound instruction signal may be transmitted from the portable device 10 to the electronic musical instrument 80. A play position is indicated by the play marker PM. When the user changes a position of the play marker PM, the play position in the sound control data 125 can also be changed.

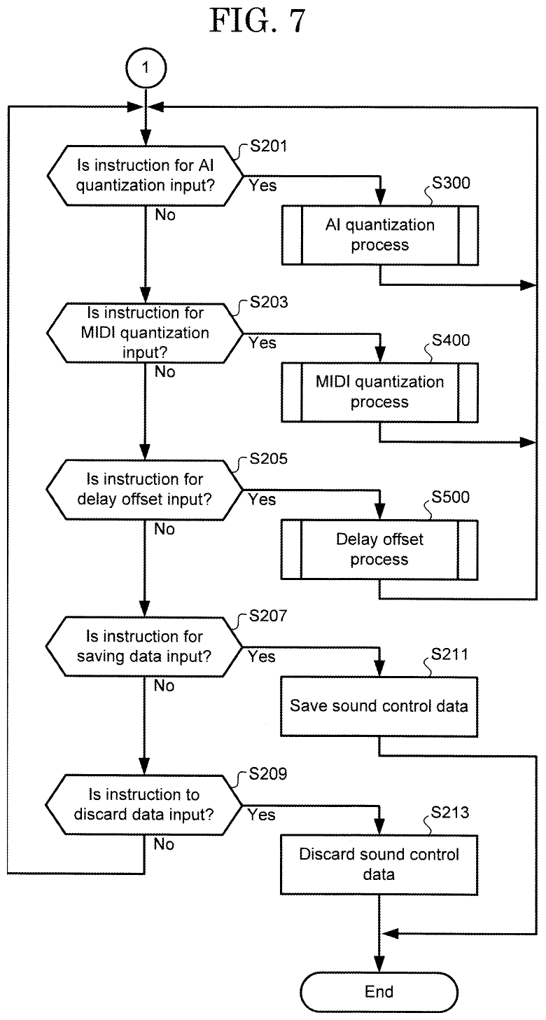

FIG. 7 is a flowchart showing a process of a recording mode (a part subsequent to FIG. 3) according to an embodiment. The control unit 110 waits for an instruction to be input by the user to the interface SD (step S201; No, S203; No, S205; No, S207; No, and S209; No). A state in which the control unit 110 waits for the instruction in this way is referred to as an instruction waiting state.

When an instruction for the AI quantization is input by operating the modification selection button AB (step S201; Yes), the control unit 110 executes an AI quantization process (step S300), and returns to the instruction waiting state. The AI quantization process will be described later.

When an instruction for the MIDI quantization is input by operating the modification selection button MB (step S203; Yes), the control unit 110 executes a MIDI quantization process (step S400), and returns to the instruction waiting state. The MIDI quantization process will be described later.

When the instruction for the delay offset is input by operating the modification selection button DB (step S205; Yes), the control unit 110 executes a delay offset process (step S500), and returns to the instruction waiting state. The delay offset process will be described later.

When an instruction for saving data is input by operating the save button B1 (step S207; Yes), the control unit 110 saves the sound control data 125 (step S211), and ends the process of the recording mode. When an instruction to discard data is input by operating the delete button B2 (step S209; Yes), the control unit 110 discards the sound control data 125 (step S213), and ends the process of the recording mode.

### 4. AI Quantization Process

Next, the AI quantization process will be described.

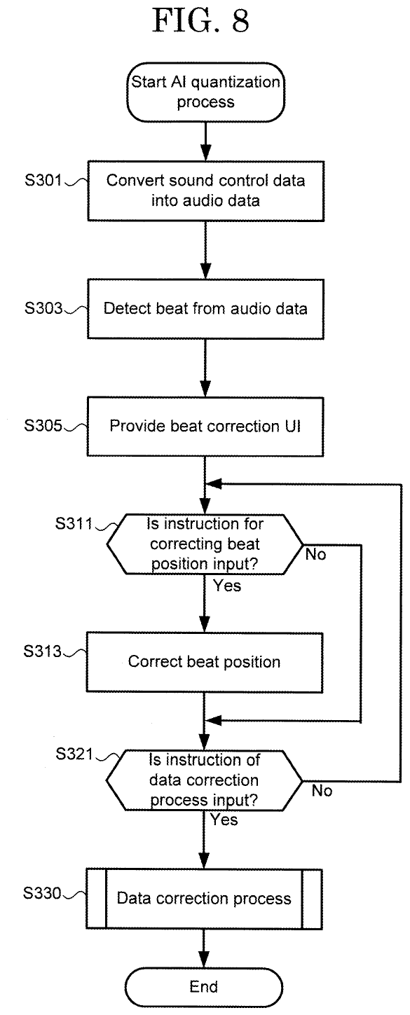

FIG. 8 is a flow chart showing an AI quantization process according to an embodiment. The control unit 110 converts the sound control data 125 into audio data (step S301). The audio data is data indicating sound according to timing information defined in the sound control data 125 as a sound waveform signal. The sound waveform signal may be generated by the portable device 10 or may be generated by the electronic musical instrument 80 and received by the portable device 10. The control unit 110 detects a beat based on the audio data (step S303).

The beat can be detected based on a variation in amplitude of the acoustic waveform signal or the like. In this case, the AI technique is used for detecting the beat. A beat position can be acquired from a learned model by inputting the audio data obtained by the conversion into the learned model in which a relationship between the audio data and the beat position is learned. A specific method for detecting the beat is not limited to using the AI technique, and a known method for detecting the beat can be applied. The beat detection may be performed not only on the audio data but also on the sound control data 125.

The control unit 110 provides a beat correction interface (beat correction UI: first user interface) by displaying an image to be described below on the display unit 130 (step S305). The control unit 110 waits until an instruction for correcting the beat position or an instruction for a data correction process is input to the beat correction interface (step S311; No, S321; No). When the instruction for correcting the beat position is input (step S311; Yes), the control unit 110 corrects the beat position (step S313) and waits again (step S311; No, S321; No). When the data correction process is instructed (step S321; Yes), the control unit 110 executes the data correction process (step S330), and ends the AI quantization process. In some cases, the instruction for correcting the beat position is not input, and the data correction process is instructed. In this case, the data correction process is executed using the detected beat position as it is.

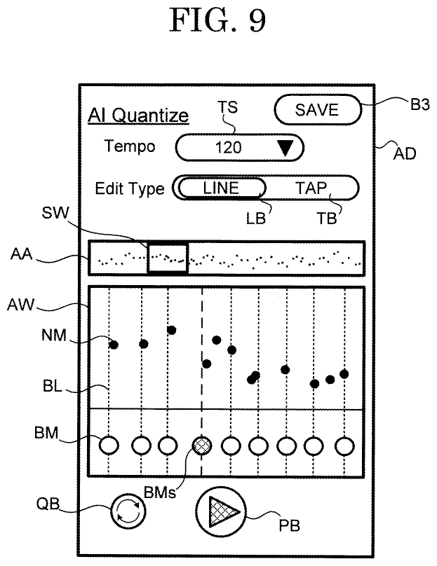

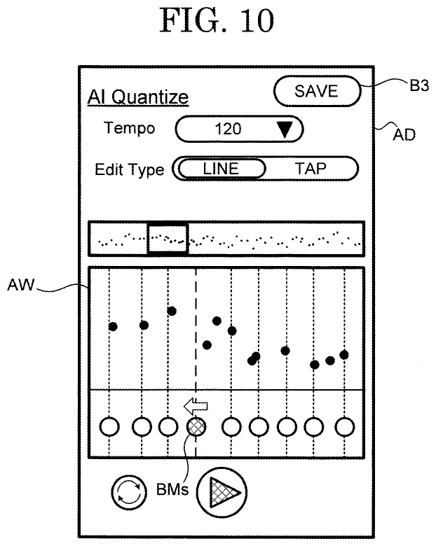

FIG. 9 is a diagram showing an example of a beat correction user interface (before a correction instruction). FIG. 10 is a diagram showing an example of a beat correction user interface (before a correction instruction). A beat correction interface (hereinafter, sometimes referred to as an interface AD) includes a region TS for setting an average tempo, a line button LB and a tap button TB for setting a method for editing the beat position, a play button PB, a re-detection button QB, and a save button B3. As the average tempo, a tempo (recording tempo) at the time of recording the sound control data 125 is displayed as an initial value. Normally, it does not need to be modified from the initial value, but may be modified. The interface AD described in FIG. 9 and FIG. 10 are shown as editing methods in the case where the line button LB is operated.

The interface AD further includes an entire region AA showing the sound defined in the sound control data 125 as a range of an entire song, and an enlarged region AW showing an enlarged range specified by a selection window SW. In these regions, a vertical axis represents a pitch, a horizontal axis represents a duration, and respective sounds are indicated by a sound marking NM. The selection window SW can modify its position in the entire region AA, and can also modify an enlarge rate in a time axis direction when displayed in the enlarged region AW by modifying a length in a horizontal axis direction.

The beat position detected based on the sound control data 125 is indicated by a beat position line BL in the enlarged region AW. A circular beat marker BM is displayed below the beat position line BL. The beat marker BM is used when the user corrects the beat position. In the beat marker BM, a beat marker BMs designated by the user as the modification target is displayed in a form distinguishable from other beat markers BM. At this time, as shown in FIG. 9, a display form of the beat position line BL corresponding to the beat marker BMs may also modify.

If the beat marker BMs designated by the user in FIG. 9 is shifted to the left side as shown in FIG. 10, this corresponds to inputting the beat position correction instruction (step S311; Yes in FIG. 8). Accordingly, the control unit 110 corrects the beat position corresponding to the beat marker BMs to a position of the beat marker BMs after the moving (step S313 in FIG. 8). Such correction is performed in the case where the detected beat position is different from the beat position assumed by the user.

If the play button PB is operated, the control unit 110 plays a sound corresponding to the sound control data 125 in a region displayed on the enlarged region AW. In this case, a sound (metronome sound) indicating a beat may be generated at the detected beat position. In this way, the user may be made to recognize a relationship between the detected beat position or the corrected beat position and the sound timing by the sound.

If the re-detection button QB is operated, the control unit 110 returns to step S303 to detect the beat. In the case where a beat whose position is corrected by the user exists, the control unit 110 may perform the beat detection process by fixing the corrected beat position.

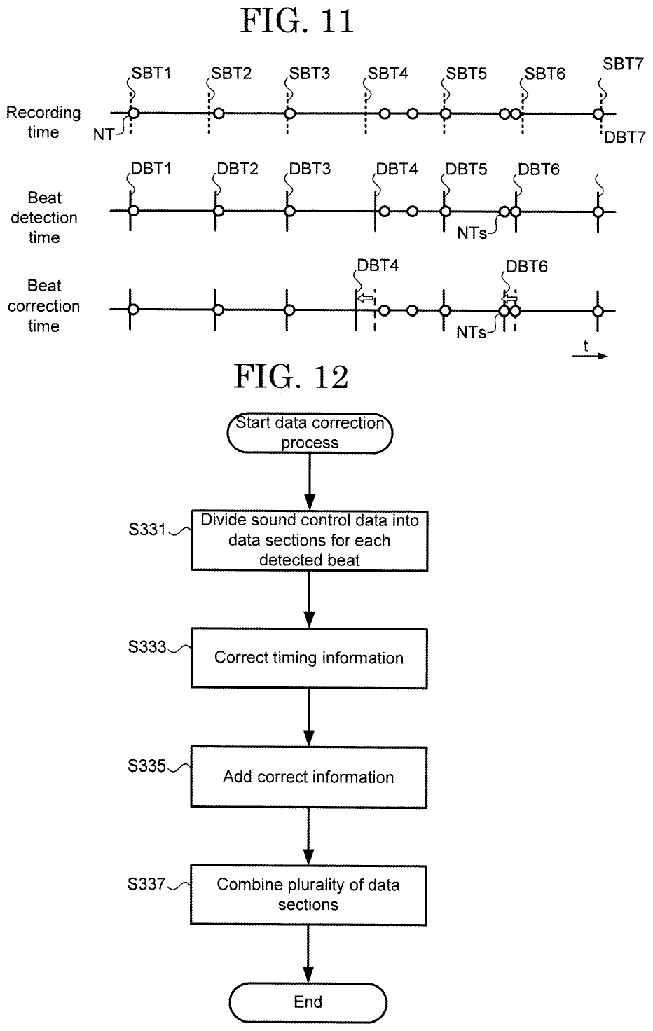

FIG. 11 is a diagram for explaining an example of sound control data. FIG. 11 shows a relationship between the timing information of the sound control data 125 and beat positions in “recording time”, “beat detection time”, and “beat correction time”. The “recording time” indicates the sound control data 125 when recorded in the recording mode. The “beat detection time” indicates the sound control data 125 when a beat is detected in the AI quantization process. The “beat correction time” indicates the sound control data 125 when the detected beat position is corrected by the user. A horizontal axis represents time t. A sound NT indicates a sound position corresponding to timing information. Since the sound control data 125 is not modified during a period from the recording time to the beat correction time, a position of the sound NT is not modified.

Beat positions SBT1, SBT2, . . . indicate beat positions at the recording time. Therefore, a length of each beat is the same. Beat positions DBT1, DBT2, . . . indicate beat positions when the beats are detected. The detected beat positions are not necessarily at equal intervals. Therefore, in an example of FIG. 11, there is a beat whose position (timing) is shifted between the recording time and the beat detection time. In the beat correction time, a beat after the beat position is corrected by moving the beat marker BMs in the interface AD is shown. In FIG. 11, examples of corrected beat positions DBT4 and DBT6 are shown. A correction of the beat position DBT4 corresponds to the example shown in FIG. 10. A correction of the beat position DBT6 is a correction for aligning a grace note NTs with the beat position. A purpose of correcting in this way is related to data reproduction process, and will be described later.

Operating the save button B3 in the interface AD corresponds to inputting the instruction for the data correction process (step S321; Yes). Accordingly, if the save button B3 is operated, the control unit 110 executes the data correction process (step S330). At this time, the portable device 10 may transmit the sound control data 125 or the audio data and data indicating the corrected beat position in association with each other to the data management server 90. The data management server 90 registers the data received from the portable device 10 in database in the storage unit 920. The data management server 90 can execute the process using the data registered in the database. For example, the data corrected by the user can be used to improve accuracy of a beat detection technique or to improve accuracy of the AI technique in the beat detection (updating a learned model using the registered data as teacher data and the like).

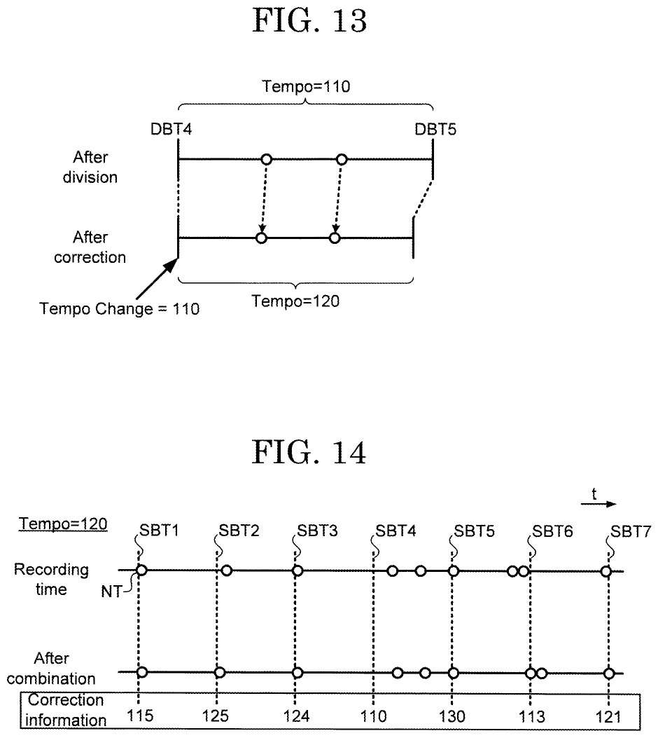

FIG. 12 is a flowchart showing a data correction process according to an embodiment. The control unit 110 divides the sound control data 125 at the positions of the beat positions DBT1, DBT2, . . . described above, and thereby divides the sound control data 125 into data sections for each detected beat (corrected beat if corrected) (step S331). The control unit 110 expands and contracts a plurality of divided data sections to a length corresponding to the average tempo described above (length of one beat corresponding to the average tempo), and corrects the position of each sound included in each of the data sections, that is, the timing information, so as to correspond to the amount of expansion and contraction (step S333). The control unit 110 adds correction information corresponding to a correction amount of the timing information to each of the data sections (step S335), and combines the plurality of data sections in which the correction information whose timing information is corrected is added (step S337). The data correction process will be described in more detail with reference to FIG. 13 and FIG. 14.

FIG. 13 is a diagram for explaining an example of correcting timing information. FIG. 13 shows an example of method for correcting timing information in a data section between the beat position DBT4 and the beat position DBT5 among the plurality of data sections. “After division” indicates the sound control data 125 in the data section before correction. “After correction” indicates the sound control data 125 after the timing information is corrected. In this example, a data section length before correction (length between the beat position DBT4 and the beat position DBT5) corresponds to the tempo “110”.

In this example, the average tempo is set to “120”. Therefore, the data section length is modified to a length corresponding to the tempo “120”. Since the data section length is multiplied by “110/120”, the timing information of the sound included in the data section is corrected to a position multiplied by “110/120” based on a head of the beat (beat position DBT4). Thus, the correction amount is “110/120”. The correction information is added as a tempo value “110” corresponding to the original data section length as a value corresponding to the correction amount at the position corresponding to the beat position DBT4. It may be added as a relative value to the average tempo as “110/120”. In the case where the data is in the MIDI format, the correction information is added as information of a tempo change. If the sound control data 125 in the corrected data section in this way is reproduced with the tempo “110”, the performance sound at the same timing as when the sound control data 125 is recorded can be played.

FIG. 14 is a diagram for comparing and explaining the sound control data before and after the modification. FIG. 14 shows a relationship between the timing information of the sound control data 125 and the beat position at the “recording time” and “after combination”. The “recording time” indicates the sound control data 125 that is recorded in the recording mode, that is, prior to the timing information being modified by the AI quantization process. The “after combination” indicates the sound control data 125 after combining the data sections in which the timing information are corrected by the AI quantization process and the correction information is added, that is, after the timing information is modified. As shown in FIG. 14, in the AI quantization process, the sound control data 125 is modified by aligning the detected beat (or the further corrected beat) to a predetermined tempo (in this example, the average tempo) and adding correction information corresponding to the correction amount (in this example, the tempo value corresponding to a length of the original beat) so that the length of the original beat can be specified.

When the timing information is modified by the AI quantization process as described above, the sound control data 125 can take the data format described as a fixed tempo, and can reproduce the performance sound when the sound control data 125 is recorded by reflecting and reproducing the corrected information as a tempo modification. This is particularly useful for songs that want to reproduce a natural performance. AI quantization process has been described above.

### 5. MIDI Quantization Process

Next, the MIDI quantization process will be described.

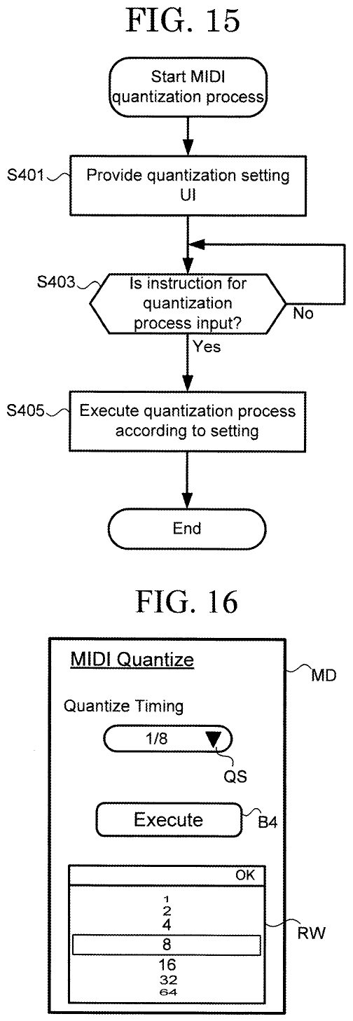

FIG. 15 is a flow chart showing a MIDI quantization process according to an embodiment. The control unit 110 provides a quantization setting user interface (quantization process setting UI) by displaying an image to be described below on the display unit 130 (step S401), and waits until an instruction for the quantization process is input (step S403; No). When the instruction for the quantization process is input (step S403; Yes), the control unit 110 executes the quantization process according to the setting (step S405), and ends the MIDI quantization process.

FIG. 16 is a diagram showing an example of a quantization setting user interface. The quantization setting user interface (hereinafter, sometimes referred to as an interface MD) includes a region QS for setting a resolution of quantization, and an execution button B4 for inputting the instruction for the quantization process. In this example, the interface MD includes a window RW for selecting the resolution to be set. If the resolution of the quantization is “⅛”, the timing information is corrected so that the timing is aligned in units of eighth notes. This process is similar to a general quantization process. The interface MD may include a region for setting a condition of a sound that is not subject to the quantization. For example, the sound that is not subject to the quantization may be moved at the same volume as a target sound of the nearest quantization. For example, the sound that is not subject to the quantization process may be a sound having a length of half or less of the resolution, or a sound having a velocity (volume) smaller than a predetermined value. Conversely, the interface MD may include a region in which a target sound of the quantization can be designated.

According to the MIDI quantization process, in the case where a rhythm is shaken during the performance of recording the sound control data 125, it is possible to eliminate the shake of the rhythm of the sound included in the sound control data 125 and align rhythm to the beat position. This process is particularly effective for songs whose rhythm is important, such as dance music. The MIDI quantization has been described above.

### 6. Delay Offset Process

Next, the delay offset process will be described.

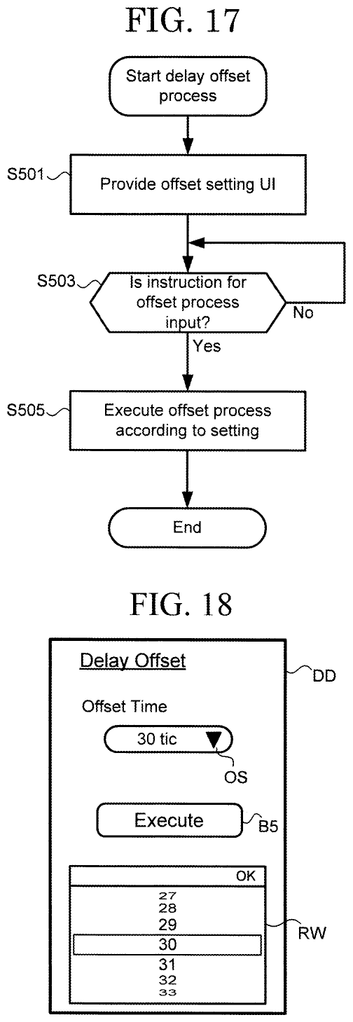

FIG. 17 is a flowchart showing a delay offset process according to an embodiment. The control unit 110 provides an offset setting user interface (offset setting UI: second user interface) by displaying an image to be described below on the display unit 130 (step S501), and waits until an instruction for an offset process is input (step S503; No). When the instruction for the offset process is input (step S503; Yes), the control unit 110 executes the offset process according to the setting (step S505), and ends the delay offset process.

FIG. 18 is a diagram showing an example of an offset setting user interface. The offset setting user interface (hereinafter, sometimes referred to as an interface DD) includes a region OS for setting an offset amount, and an execute button B5 for inputting the instruction for the offset process. In this example, the interface DD includes the window RW for selecting the offset amount to be set. If the offset amount is “30”, the sound control data 125 is modified by correcting the timing information so as to delay the overall by 30 ticks.

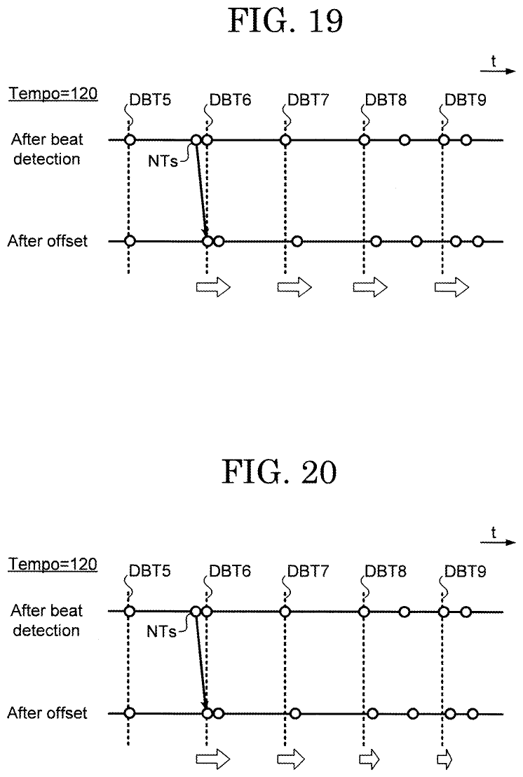

The interface DD may have a region for specifying a sound to be processed. By specifying the sound to be processed, the timing information may be corrected for the target sound and a plurality of sounds following the target sound. In the case where the sound to be processed is not specified, a first sound of the sound control data 125 may be specified as the sound to be processed. Two examples will be described with reference to FIG. 19 and FIG. 20 in the case where correction is performed by specifying the sound to be processed.

FIG. 19 and FIG. 20 are diagrams for comparing and explaining the sound control data before and after the delay offset. FIG. 19 and FIG. 20 both show a relationship between the timing information of the sound control data 125 and the beat position at “beat detection time” and “after offset”. The “beat detection time” indicates the sound control data 125 when a beat is detected in the AI quantization process. The “after offset” indicates the sound control data 125 after the grace note NTs is specified as the sound to be processed and the offset process is executed. Since it is assumed that the grace note is aligned with the beat position by the offset process, it is assumed that the offset amount is specified so as to move the grace note NTs to the beat position DBT6.

In the first example shown in FIG. 19, the timing information is corrected so that the grace note NTs moves to the beat position DBT6 in accordance with the offset amount. The timing information is corrected by the same offset amount for each of a plurality of sounds following the grace note NTs. In this case, a position of the correction information may be further modified. The modification of the position of the correction information corresponds to the modification of the data section corrected by the correction information. An amount by which the position of the correction information is modified may correspond to the offset amount.

In the second example shown in FIG. 20, the timing information is corrected so as to move to the beat position DBT6 in the same manner for the grace note NTs. On the other hand, for the plurality of sounds following the grace note NTs, the timing information is corrected so that the farther from the grace note NTs, the smaller the offset amount is. In this case, the timing information may be corrected only for sounds within a predetermined number of beats (for example, within four beats) from the grace note NTs.

### 7. Data Reproduction Process

Next, a process for reading the sound control data 125 generated as described above (for example, the sound control data 125 “after combination” shown in FIG. 14) and reproducing the sound waveform signal in the sound source unit 830 will be described. The portable device 10 outputs a sound instruction signal based on the sound control data 125 to the electronic musical instrument 80 in order to cause the sound source unit 830 to reproduce the sound waveform signal. When the portable device 10 receives an instruction to start the reproduction process of the sound control data 125 by the user, the portable device starts the data reproduction process. In the data reproduction process, a mode in which the sound control data 125 is reproduced includes an auto mode and a control mode.

The auto mode is a mode for reading the sound control data 125 with a predetermined tempo, correcting a tempo by using correction information set corresponding to each beat, thereby realizing reproduction of the sound waveform signal at a timing at which the beat position is substantially corrected, and reproducing the performance sound when the data is recorded. In the case where the correction information is not used when the sound control data 125 is read out, as shown in FIG. 14, although a performance sound different from the performance sound when the data is recorded is reproduced, the performance sound when the data is recorded can be reproduced by modifying the speed at which the data is read out using the correction information. In the case where the sound control data 125 in which the AI quantization process is not executed is used, the sound control data 125 is read out with a predetermined tempo because the correction information is not included.

The control mode is a mode for reading the sound control data 125 in accordance with a progress instruction signal for progressing the beat and reproducing the sound in the case where the sound is played at a speed corresponding to the signal. By a progress of the beat being instructed by the progress instruction signal, in the reading of the sound control data 125, the timing at which each beat is started is controlled, and the tempo between beats is controlled based on previously indicated beat intervals. The progress instruction signal is generated in accordance with an operation of the user, and is generated in accordance with, for example, a timing of changing a shaking direction in an operation of shaking the portable device 10 like a command bar. If the beats arranged at regular intervals in the sound control data 125 are in the MIDI format, the control unit 110 can identify the position of the beats based on the tick value. A data position to which the correction information is added in the sound control data 125 may be specified as the beat position.

It may be desirable to make corrections to align the grace notes with the beat position as described above. The grace notes are often located a little ahead the beat position. In such a case, it is desirable that the ornamented note existing at the beat position and the grace note existing ahead it are played continuously. On the other hand, in the case of operating under the control mode, since the sound control data 125 is read out using the beat position as a break, the grace note is played at an early timing, so that a situation in which the grace note and the ornamented note are played far apart occurs. Assuming such a case, by the timing information being corrected so that the grace note is positioned at the beat position, the grace note and the ornamented note can be played as a single unit without being separated from each other.

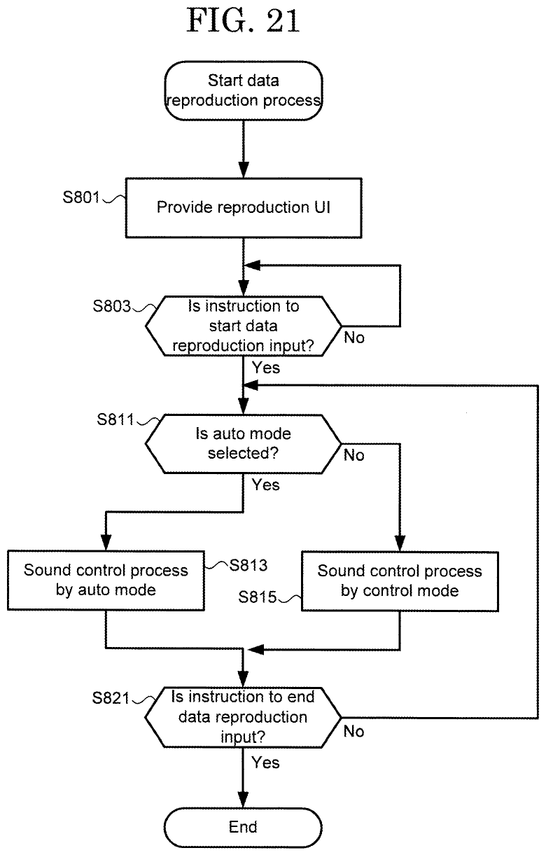

FIG. 21 is a flowchart showing a data reproduction process according to an embodiment. The control unit 110 provides a reproduction user interface (reproduction UI) by displaying an image to be described below on the display unit 130 (step S801), and waits until an instruction to start data reproduction is input (step S803; No).

When the instruction to start data reproduction is input (step S803; Yes), the control unit 110 executes a sound control process by reproducing the sound control data 125 until an instruction to stop data reproduction is input (step S821; No). When the auto mode is selected as the reproduction mode (step S811; Yes), the control unit 110 executes the sound control process under the auto mode (step S813). On the other hand, when the auto mode is not selected, that is, when the control mode is selected as the reproduction mode (step S813; No), the sound control process under the control mode is executed (step S815). When the instruction to stop data reproduction is input (step S821; Yes), the control unit 110 ends the data reproduction process.

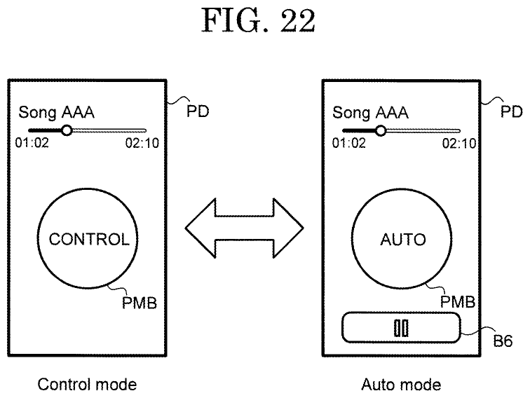

FIG. 22 is a diagram showing an example of a reproduction user interface. The reproduction user interface (hereinafter sometimes referred to as an interface PD) includes a switch button PMB for switching between the auto mode and the control mode. The switch button PMB includes images indicating whether the reproduction is operating under the auto mode or the control mode. Each time the switch button PMB is operated, the mode may be selected so as to be switched, or one of the modes (for example, the control mode) may be selected only while operating the switching button PMB (while touching the switching button PMB).

When the reproduction is operating under the auto mode, a stop button B6 is displayed to stop the progress of the song. Under the control mode, when the user stops the operation of swinging the portable device 10, the progress of the song is stopped, so that the stop button B6 may not be displayed as shown in FIG. 22. An operation of the stop button B6 corresponds to an input of the instruction to stop data reproduction (step S821; Yes), but may be recognized as an instruction to pause data reproduction by returning to the step S803.

As described above, according to a data modification method of an embodiment, the sound control data 125 recorded in accordance with the performance can be modified to data that can be used in a plurality of different reproduction methods such as the auto mode and the control mode. In addition, the sound control data 125 can be modified by selecting an appropriate modification mode according to the song.

### 8. Modifications

The present disclosure is not limited to the embodiments described above, and includes various other modifications. For example, the embodiments described above have been described in detail for the purpose of explaining the present disclosure clearly, and are not necessarily limited to those having all the described configurations. It is possible to add, delete, or replace a part of the configuration of each embodiment with another configuration. Some modification examples will be described below.
(1) In the AI quantization process, the correction data is added for each beat, but may be added for each of two or more beats, or may be added for each sound.
(2) The interface SD may be able to select a process of analyzing images of a musical score, extracting a bar line, a note, a performance symbol, and the like, and correcting timing information of the sound control data 125 based on the extracted information.
(3) When the data reproduction method is executed under the control mode, although the progress instruction signal is generated in response to the operation of shaking the portable device 10, the progress instruction signal may be generated by the operation of shaking a sensor terminal connected to the portable device 10 via the interface 190. For example, the sensor terminal may include an acceleration sensor, a gyro sensor, and the like as a configuration corresponding to the sensor unit 150, and only needs to have a function for measuring the movement of the sensor terminal and a function for connecting to the interface 190 of the portable device 10. In the case where the sensor terminal is used, the portable device 10 may be realized by a stationary desktop personal computer or the like instead of a portable device. Some or all of the functions described above implemented in the portable device 10 may be implemented by an information processing device such as one or more servers connected to the portable device 10 via the networked NW. For example, when the sound control data 125 is recorded in the recording mode, the portable device 10 transmits the sound control data 125 to the server. The server may execute a process for modifying the sound control data 125 and transmit the modified sound control data 125 to the portable device 10.

### 9. Overview of Solutions

According to an embodiment of the present disclosure described above, it is possible to describe the configuration as follows.

The data modification method of the present disclosure includes: providing a selection user interface for selecting a modification mode to be applied to sound control data defining timing information of a sound generation from a plurality of modification modes including a first modification mode and a second modification mode; modifying the sound control data by correcting the timing information and adding correction information according to an amount of correction of the timing information in a predetermined data section to the predetermined data section, in a case where the first modification mode is selected to be applied; and modifying the sound control data by correcting the timing information based on beat positions according to a predetermined tempo, in the case where the second modification mode is selected to be applied.

The data modification method of the present disclosure may provide a recording user interface for setting a tempo to instruct performance recording, may provide beat information with the set tempo when a start of the performance recording is instructed, and record the sound control data based on the performance information input while providing the beat information, and may provide the selection user interface for selecting a modification mode to be applied to the recorded sound control data when a stop of the performance recording is instructed.

The data modification method of the present disclosure may further include a third modification mode, and may modify the sound control data by modifying timing information of a specified predetermined sound and modifying timing information of a plurality of sounds following the predetermined sound in the case where applying the third modification mode is selected.

The data modification method of the present disclosure includes modifying the sound control data by detecting positions of a plurality of beats based on sound control data defining timing information of sound recorded with a predetermined tempo, correcting the timing information based on a relationship between the positions of the plurality of beats and the tempo, and modifying the sound control data by adding correction information corresponding to a correction amount of timing information in a data section to a predetermined data section.

The data modification method of the present disclosure may further include providing beat information with a predetermined tempo, and recording the sound control data based on performance information input while providing the beat information, and the correction information may be added corresponding to a provision timing of the beat information.

Detecting the positions of the plurality of beats may include converting the sound control data into audio data and detecting the positions of the plurality of beats based on the audio data.

The data modification method of the present disclosure may further include providing a first user interface for correcting the detected beat positions, and modifying the sound control data may include correcting the timing information based on a relationship between the positions of the plurality of beats corrected via the first user interface and the set tempo.

In the data modification method of the present disclosure, the recorded sound control data or the audio data and the beat position corrected via the first user interface may be registered in a database in association with each other.

The data modification method of the present disclosure may provide a second user interface for correcting timing information of a predetermined sound in the sound control data, and may further modify the sound control data by correcting the timing information of the predetermined sound instructed via the second user interface and further correcting timing information of a plurality of sounds following the predetermined sound.

In the data modification method of the present disclosure, the timing information of the predetermined sound instructed via the second user interface may be corrected, and when the timing information of the plurality of sounds following the predetermined sound is further corrected, the sound control data may be further modified by further modifying a data section to be the target of the correction information.

The data reproduction method of the present disclosure is a data reproduction method for reproducing a sound waveform signal by a sound source unit based on the sound control data modified by the data modification method described above, and provides a third user interface for selecting a sound instruction signal for causing the sound source unit to reproduce the sound waveform signal from a plurality of reproduction methods including a first reproduction method and a second reproduction method. In the case where the first reproduction method is selected, the sound control data is read out according to a predetermined tempo, the sound instruction signal is generated using the correction information, and in the case where the second reproduction method is selected, the sound control data of the data section corresponding to a progress instruction signal for progressing a beat is read out to generate the sound instruction signal.

The data modification method of the present disclosure includes providing a recording user interface for instructing performance recording, recording sound control data defining timing information of sound based on input performance information when the start of the performance recording is instructed, and providing a selection user interface for selecting a modification mode to be applied to the recorded sound control data when the stop of the performance recording is instructed from the plurality of modification modes including the first modification mode and the second modification mode, modifying the sound control data based on the selected modification mode, and playing a performance sound based on the modified sound control data.

According to the present disclosure, the data modification method or the data reproduction method can be used as a program for causing a computer to execute the data modification method or the data reproduction method, and can also be used as a data modification device for executing the data modification method and a data reproduction device for executing the data reproduction method. That is, at least a part of the portable device 10 can function as a data modification device or a data reproduction device.

What is claimed is:

1. A data modification method of controlling sound, the method comprising:
providing a selection user interface that allows a user to select a modification mode to be applied to sound control data defining timing information of a sound generation from among a plurality of modification modes including a first modification mode and a second modification mode;
modifying the sound control data by correcting the timing information and adding correction information according to an amount of correction of the timing information in a predetermined data section to the predetermined data section, in a state where the first modification mode is selected to be applied; and
modifying the sound control data by correcting the timing information based on beat positions according to a predetermined tempo, in a state where the second modification mode is selected to be applied.

2. The data modification method according to claim 1, further comprising:
providing a recording user interface that allows the user to set a tempo and instruct performance recording;
providing beat information with the set tempo after a start of the performance recording is instructed;
recording the sound control data based on performance information input while providing the beat information; and
providing the selection user interface to allow the user to select the modification mode to be applied for the recorded sound control data, after a stop of the performance recording is instructed.

3. The data modification method according to claim 1, wherein:
the plurality of modification modes include a third modification mode, and
the data modification method further comprises modifying the sound control data by correcting the timing information of specified predetermined sound and correcting the timing information for a plurality of sounds following the specified predetermined sound, in a state where the third modification mode is selected to be applied.

4. A data modification method of controlling sound, the method comprising:
detecting a plurality of beat positions from sound control data defining timing information of sounds recorded with a predetermined tempo;
correcting the timing information based on a relationship between the plurality of beat positions and the predetermined tempo; and
modifying the sound control data by adding correction information to a predetermined data section according to an amount of correction of the timing information in the predetermined data section.

5. The data modification method according to claim 4, further comprising:
providing beat information with the predetermined tempo; and
recording the sound control data based on performance information input while providing the beat information,
wherein the correction information is added in correspondence with a timing of providing the beat information.

6. The data modification method according to claim 4, wherein the detecting of the plurality of beat positions includes converting the sound control data into audio data and detecting the plurality of beat positions from the audio data.

7. The data modification method according to claim 6, further comprising:
providing a user interface for correcting the detected plurality of beat positions,
wherein the modifying of the sound control data includes correcting the timing information based on a relationship between the plurality of beat positions corrected via the user interface and the predetermined tempo.

8. The data modification method according to claim 7, further comprising registering the recorded sound control data or the audio data and the plurality of beat positions corrected via the user interface in the database in association with each other.

9. The data modification method according to claim 4, further comprising:
providing a user interface for correcting timing information of predetermined sound in the sound control data; and
further modifying the sound control data by correcting the timing information of the predetermined sound instructed via the user interface and further correcting timing information of a plurality of sounds following the predetermined sound.

10. The data modification method according to claim 9, wherein the sound control data is further modified by modifying a data section subject to the correction information, in a state where the timing information of the predetermined sound instructed via the user interface is corrected and the timing information of the plurality of sounds following the predetermined sound is further corrected.

11. A data reproduction method of reproducing a sound wave form signal by a sound signal processor based on the sound control data modified by the data modification method according to claim 4, the data reproduction method comprising:
providing a user interface that allows a user to select a method for generating a sound instruction signal to cause the sound processor to reproduce the sound waveform signal among a plurality of reproducing methods including a first reproducing method and a second reproducing method,
reading the sound control data in accordance with a predetermined tempo and generating the sound instruction signal using the correction information, in a state where the first reproducing method is selected; and
reading the sound control data of the data section corresponding to a progression instruction signal to progress a beat and generating the sound instruction signal, in a state where the second reproducing method is selected.

12. A data modification method of controlling sound, the method comprising:
providing a recording user interface that allows a user to instruct performance recording;
recording sound control data defining timing information of a sound generation based on input performance information, after a start of the performance recording is instructed,
providing a selection user interface that allows the user to select a modification mode to be applied to the recorded sound control data from among a plurality of modification modes including a first modification mode and a second modification mode, after a stop of the performance recording is instructed,
modifying the sound control data based on the selected modification mode; and
playing back performance sounds based on the modified sound control data.

13. The data modification method according to claim 12, wherein:
the plurality of modification modes include a third modification mode, and
the data modification method further comprises modifying the sound control data by correcting the timing information of specified predetermined sound and correcting the timing information for a plurality of sounds following the specified predetermined sound, in a state where the third modification mode is selected to be applied.
